(19) United States
(12) Patent Application Publication
(10) Pub. No.: US 2015/0073830 A1
(43) Pub. Date: Mar. 12, 2015

(54) Electrical Computing Devices for Recruiting a Patient Population for a Clinical Trial

(71) Applicants: Angela Lynn Hill, Carmel, IN (US); Gavin David Thomas Nichols, Cary, NC (US); Bruce Richard Basson, Cary, NC (US); Eric Sabo, Durham, NC (US)

(72) Inventors: Angela Lynn Hill, Carmel, IN (US); Gavin David Thomas Nichols, Cary, NC (US); Bruce Richard Basson, Cary, NC (US); Eric Sabo, Durham, NC (US)

(21) Appl. No.: 14/479,963

(22) Filed: Sep. 8, 2014

Related U.S. Application Data
(60) Provisional application No. 61/874,511, filed on Sep. 6, 2013.

(51) Int. Cl. G06Q 30/02; G06F 19/00; G06Q 50/22

(52) U.S. Cl. CPC G06Q 30/0204; G06Q 50/22; G06F 19/322
USPC 705/3

(57) ABSTRACT

One disclosed method includes obtaining an electronic representation of a primary patient population within a first data store, the primary patient population comprising a plurality of electronic health records (EHRs); receiving an electronic representation of a target secondary patient population, the target secondary patient population comprising a target number of patients and at least one characteristic; and generating an electronic representation of the secondary patient population from the primary patient population based on the target number of patients and the at least one characteristic.

### CROSS-REFERENCE TO RELATED APPLICATION

This claims priority to U.S. Provisional Patent Application No. 61/874,511, titled “Electrical Computing Devices for Recruiting a Patient Population for a Clinical Trial” and filed Sep. 6, 2013, the entirety of which is hereby incorporated by reference.

### FIELD

The present disclosure generally relates to electrical computer-implemented systems and methods for recruiting and locating patients for a clinical trial.

### BACKGROUND

Clinical trials can be performed to assess the safety and efficacy of health interventions, such as drugs, diagnostics, and therapies. Clinical trials can be complicated in that clinical trials often involve, among other things, locating and recruiting patients to participate in the clinical trial. In particular, clinical trials can involve locating and recruiting patients that meet certain characteristics necessary for the clinical trial. For example, clinical trials can involve locating and recruiting patients that meet a certain demographic, a certain age, gender, etc. Locating and recruiting patients that meet certain criteria can be challenging.

### SUMMARY

Various examples are described for electrical computing devices for recruiting a patient population for a clinical trial.

One example method includes obtaining an electronic representation of a primary patient population within a first data store, the primary patient population comprising a plurality of electronic health records (EHRs); receiving an electronic representation of a target secondary patient population, the target secondary patient population comprising a target number of patients and at least one characteristic; and generating an electronic representation of the secondary patient population from the primary patient population based on the target number of patients and the at least one characteristic. Another example includes a computer-readable medium comprising program code for causing a processor to execute such a method.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 depicts an example of an environment in which certain aspects may be implemented;

FIG. 2 depicts a block diagram with an example of a computing device from the environment of FIG. 1 according to one aspect;

FIG. 3 depicts a data flow diagram that depicts an example of certain processes according to one aspect;

FIGS. 4-5 depict data flow diagrams that depict examples of certain processes according to certain aspects;

FIGS. 6-8 depict examples of user interfaces of primary criteria according to certain aspects;

FIGS. 9-10 depict examples of user interfaces of resultant patient populations according to certain aspects;

FIG. 11 depicts an example of user interface to receive additional or secondary search criteria to refine a patient population according to one aspect;

FIGS. 12-13 depict examples of secondary criteria according to certain aspects;

FIG. 14 depicts a flow chart of a process for obtaining data associated with a primary or secondary patient populations according to one aspect; and

FIG. 15 depicts an example of a user interface for receiving patient criteria according to one aspect.

### DETAILED DESCRIPTION

Certain aspects relate to electronic computing systems and database structures for recruiting and locating patients for a clinical trial. Electronic computing systems and database structures may be designed to enhance the likelihood that a site selected for a clinical trial can successfully locate and recruit patients for participation in the clinical trial. Electronic computing systems and database structures may also be designed to provide enhanced evidence for payers by combining medical data (e.g., electronic health records), provider data, and investigator data.

Electronic computing systems and database structures according to some aspects permit a user to recruit, locate, or select at least one patient that meets defined criteria. In some aspects, a device can be used to build a query that includes a combination of desired patient characteristics and provider characteristics. Patient characteristics can include age, demographics, diagnoses, lab values, medications, and the like. A provider may be a healthcare provider, such as a private practice doctor's office or a hospital. Provider data or characteristics can include specialty, location, number of doctors and staff, and the like. These characteristics may be queried as a binary (e.g., present/not present) or in temporal association to each other (e.g., Event A must precede Event B).

The query that includes a combination of desired patient characteristics and provider characteristics may be used to search through electronic health record (EHR) data to locate and recruit patients. In some aspects, the query can be used to search through EHR data to find healthcare providers that have de-identified patients in their medical practice that meet the patient characteristics.

In some aspects, the query may be used to search through provider data or investigator data to locate or recruit patients, providers, or investigators. In certain aspects, the identities of providers may be matched to known investigators in a separate database. The providers that are identified meeting certain specified criteria (e.g., user-specified provider characteristics) may include (1) experienced clinical trial investigators and (2) those that are currently treating patients matching the user-identified criteria. Because a user may not always have access to data containing practitioner identifiers, the device may also contain functionality to match de-identified practitioners to known clinical trial investigators in a common geographic area, identified, for example, by one or more digits of a zip code. In some cases, investigators are providers or other third parties that have participated in performing clinical trials. Investigators may maintain records of patients from prior or on-going clinical trials, or if an investigator is also a provider, it may maintain records of existing or former patients that may be suitable for a clinical trial. An investigator may have investigator data or characteristics such as a specialty, a number of clinical trials it has participated in, whether the investigator is participating in an on-going clinical trial, the types of clinical trials it has participated in, relationships with providers or patients, and the like.

Electronic computing systems and database structures according to some aspects return results from a query that may include a patient population that meets one or more patient characteristics (including characteristics of a healthcare provider of patients). For example, an application installed on a device can generate a query for patient characteristics such as all patients having diabetes being seen by a provider that specializes in endocrinology. The device may query a database of EHRs for all patients having diabetes. The device may also query a separate database of investigators and associate the providers of the patients in the database of EHRs with the investigator from the database of investigators.

The result of such query may provide a group of patients and their associated providers/practitioners that meet the desired characteristics. In some aspects, the providers may also be investigators, as identified by the match up with the investigators in the investigator database.

Electronic computing systems and database structures according to some aspects permit a user to refine the results of a query. The user may refine the results of a query by running an additional query that includes additional or secondary criteria and dimensions. The user may refine the results of the group of patient/practitioner relationships by running the additional query.

As an example, there may be numerous patients that may be identified or located that meet the inclusion/exclusion criteria of a clinical trial. The population of acceptable trial candidates, however, might be biased towards a certain gender, ethnicity, age range, etc. A secondary criteria search using a method may help the user to pick out the ideal patient/practitioner combinations based on desired characteristic distributions.

Continuing the example, a primary population of patient/practitioner relationships may include 70% males and 30% females but a drug company may project that the drug should be prescribed more or less equally among males and females. In this situation, the device can receive a request for 50% males and 50% females for the secondary criteria population of patient/practitioner relationships. A method can then calculate one or more recommended scenarios to get the desired distribution. In some aspects, the user may specify how important a given dimension is in the context of others. For example, achieving a particular gender distribution might be a high priority whereas a particular age distribution is a low priority. The method accommodates for these differences in user-defined priority.

The secondary criteria method may prioritize the selection of patients that are linked to the same practitioner over other patients associated with a different provider that also meet the desired criteria. In other words, if two patients have identical characteristics (as measured by the user-defined requested characteristics), the method may prioritize the selection of patients that are linked to practitioners that are already represented in the secondary population or those patients that are linked to the practitioners with the greatest number of patients in the primary population. With this step, the method may provide added value by honing in on practitioners that have the most (and most clinically relevant) patients. This may prioritize recruiting those investigators and starting up those sites with a history of high performance.

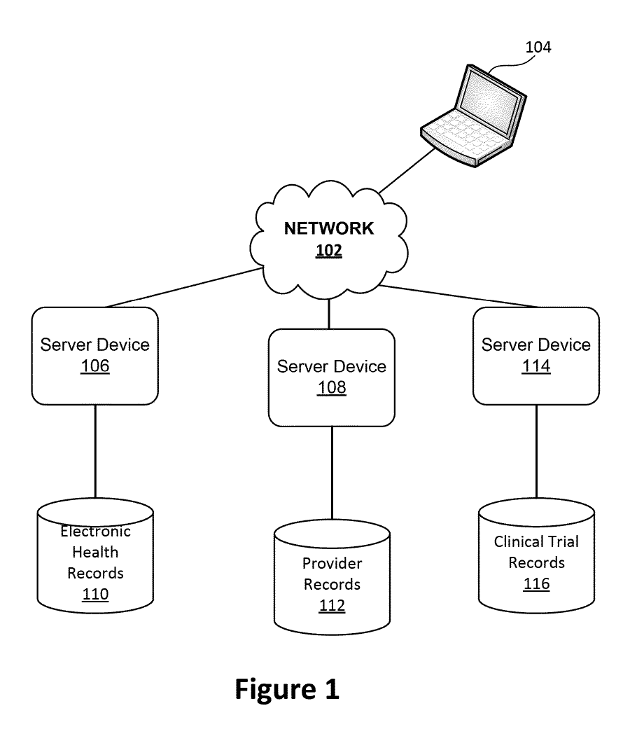

FIG. 1 is an example of an environment in which certain aspects may be implemented. The environment includes a network 102, a computing device 104, server devices 106, 108, 114, an EHR data store 110, a provider records data store 112, and a clinical trial investigator records data store 116. The computing device 104 can communicate through the network 102, which may be one or more networks, with these other devices and data stores. The server devices 106, 108, 114 may be database server devices that provide access to structured data in the EHR data store 110, the provider records data store 112, and the clinical trial investigator records data store 116, respectively, to the computing device 104 through the network 102.

In some aspects, the EHR electronic data storage device 110 and the provider records data store 112 are within the same device or are in a single database. The EHR data store 110 may be a database in which structured data sets of health information and demographic information of patients treated by physicians are stored electronically. In some aspects, the EHRs can contain health-related information about a majority of individuals in political boundary, such as country or state within a country, that have been treated by physicians.

In some aspects, the provider records data store 112 may be a database in which structured data sets of information of health providers of patients or investigators of clinical trials are stored electronically. The provider records data store 112 may be a database in which health care provider information may be electronically stored. Certain health care provider information may include the specialties of health care providers and the like.

The clinical trial investigator records data store 116 may be a database in which health information, demographic information, and other information of patients participating (or that have participated) in clinical trials are electronically stored and electronically associated with clinical trial information. The clinical trial investigator records data store 116 may include information about investigators. Information about investigators may include clinical trials currently or previously conducted by an investigator, the areas in which the investigator conducted clinical trials, and the like.

The clinical trial investigator records data store 116 may also have information about the investigators of the patient. The health information can include laboratory results, vitals, drug treatments, past drug treatments, health complaints, health conditions, diseases, etc. The demographic information can include age, race, sex, marital status, location, etc.

The computing device 104 can receive data from the EHR electronic data storage device 110, provider records data store 112, and the clinical trial investigator records data store 116 as electronic signals through server devices 106, 108, 114 and the network 102. The network 102 may be any suitable network. Examples of suitable networks include the Internet, an intranet, local area network, wireless local area network, wide area network, microwave network, satellite network, Integrated Services Digital Network, cellular network, and combinations of these or other types of networks.

The computing device 104 can permit the querying and collection of data based on query of desired patient characteristics and provider characteristics. The computing device 104 can access a provider database to access provider information based on a query of desired provider characteristics, access an EHR database to access patient information based on a query of desired provider characteristics. The computing device 104 can associate patients or providers and return patient/provider results based on the query. The computing device 104 can refine a query based on additional or secondary criteria to return results of patients or practitioners based on the secondary criteria. The computing device 104 can bring data together to generate statistics and other data on patients that meet the patient criteria and data elements of interest for the identified patients.

Although depicted separately, the server device 106 may include the EHR electronic data storage device 110, the server device 108 may include the provider records data store 112, and the server device 114 may include the clinical trial investigator records data store 116. In some aspects, the computing device 104 includes one, some or all of the EHR electronic data storage device 110, the provider records data store 112 and the clinical trial investigator records data store 116, and the environment does not include one or more of the server devices 106, 108, 114 or the network 102. In other aspects, one of the server devices 106, 108, 114 includes the computing device 104.

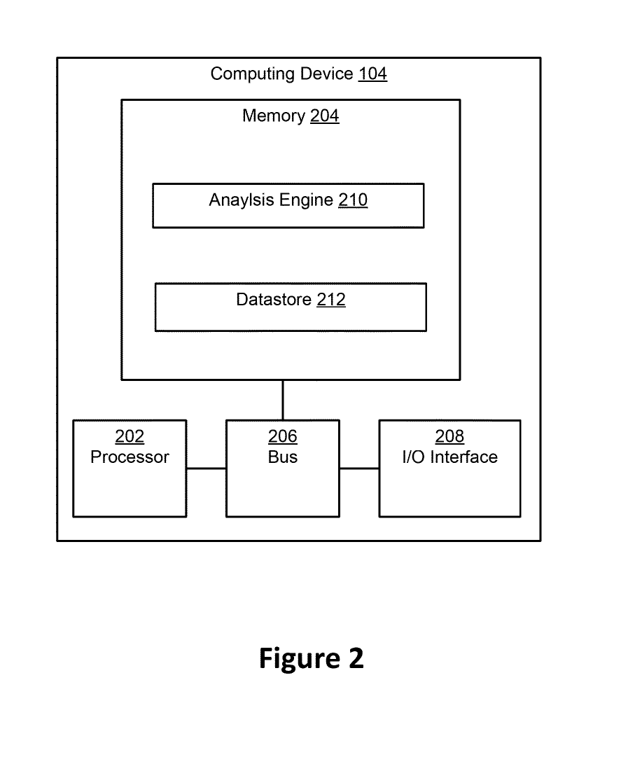

FIG. 2 depicts a block diagram with an example of the computing device 104. Other examples may be used. The computing device 104 includes a processor 202, a memory 204, and a bus 206. The memory 204 includes a tangible computer-readable memory on which code is stored. The processor 202 can execute code stored in the memory 204 by communication via the bus 206 to cause the computing device 104 to perform actions. The computing device 104 can include an input/output (I/O) interface 208 for communication with other components, such as the network 102 and server devices 106, 108, 114 of FIG. 1. The computing device 104 may be any device that can electronically process data and execute code that is a set of instructions to perform actions. Examples of the computing device 104 include a database server, a web server, desktop personal computer, a laptop personal computer, a handheld computing device, and a mobile device.

Examples of the processor 202 include a microprocessor, an application-specific integrated circuit (ASIC), a state machine, or other suitable processor. The processor 202 may include one processor or any number of processors. The processor 202 can access code stored in the memory 204 via the bus 206. The memory 204 may be any non-transitory computer-readable medium configured for tangibly embodying code and can include electronic, magnetic, or optical devices. Examples of the memory 204 include random access memory (RAM), read-only memory (ROM), a floppy disk, compact disc, digital video device, magnetic disk, an ASIC, a configured processor, or other storage device.

Instructions can be stored in the memory 204 as executable code. The instructions can include processor-specific instructions generated by a compiler, an interpreter, or both, from code written in any suitable computer-programming language. The instructions can include an application, such as an analysis engine 210, that, when executed by the processor 202, can query and collect data based on a query of desired patient characteristics or provider characteristics and return results based on the query. The instructions can include an application, such as an analysis engine 210, that, when executed by the processor 202, can refine a query based on additional or secondary criteria to return results of patients or practitioners based on the secondary criteria. The instructions can include an application, such as an analysis engine 210, that, when executed by the processor 202, can bring data together and generate statistics and other data on patients that meet the patient criteria and data elements of interest for the identified patients. The memory 204 can also include a data store 212 in which content and data can be stored.

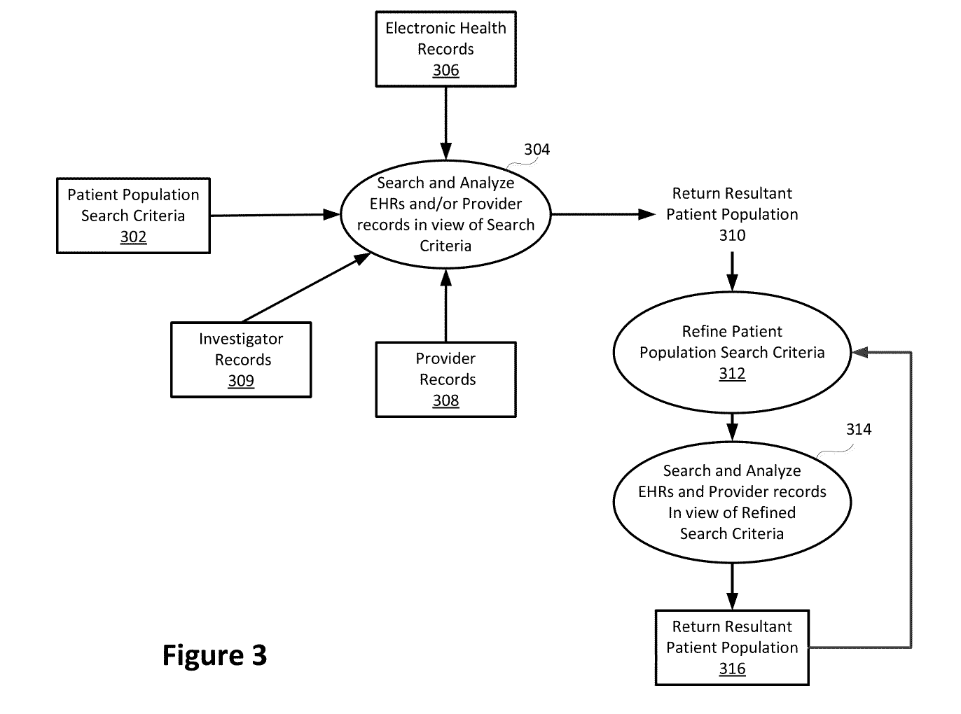

FIG. 3 is a data flow diagram that depicts an example of certain processes that can be performed by various systems according to this disclosure. In this example, the data flow diagram is discussed with respect to the computing device 104 of FIGS. 1-2. The computing device 104 with an installed application program can be used to receive search criteria 302 to run a query for patients that meet those criteria. In the example shown in FIG. 3, the search criteria 302 are received from an external data source, such as a clinical trial sponsor. However, in some aspects, the search criteria 302 may be received from other data sources, or may be generated in part or entirely on the computing device 104. Search criteria may include characteristics of patients that may be suitable for a clinical trial, or may describe a desired target patient population.

For example, search criteria may include demographic criteria, such as age and gender. In one example, a desired target patient population may have a size of 1,000 patients, with approximately 50% male and 50% female, with approximately 75% of the total population between the ages of 18-54 and the remainder with ages 55 and above. Though in some aspects, suitable patient characteristics may be specified untethered to a specific desired target population. For example, search criteria may specify female patients between the age of 12 and 75 having diabetes, but may not specify the desired target population.

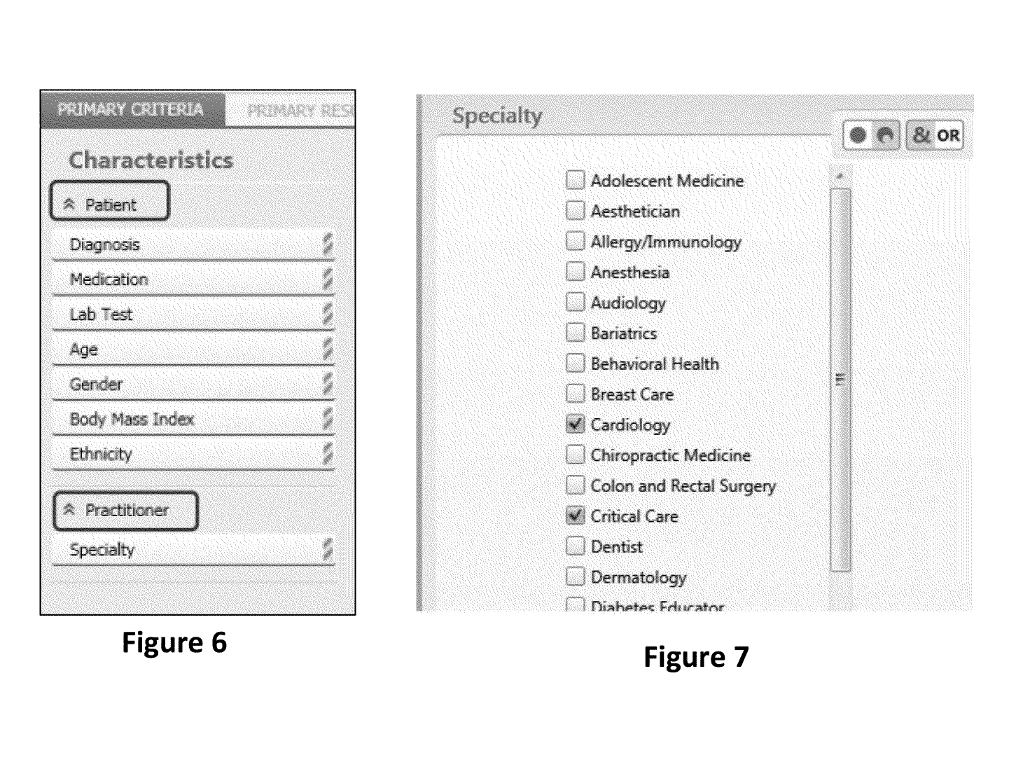

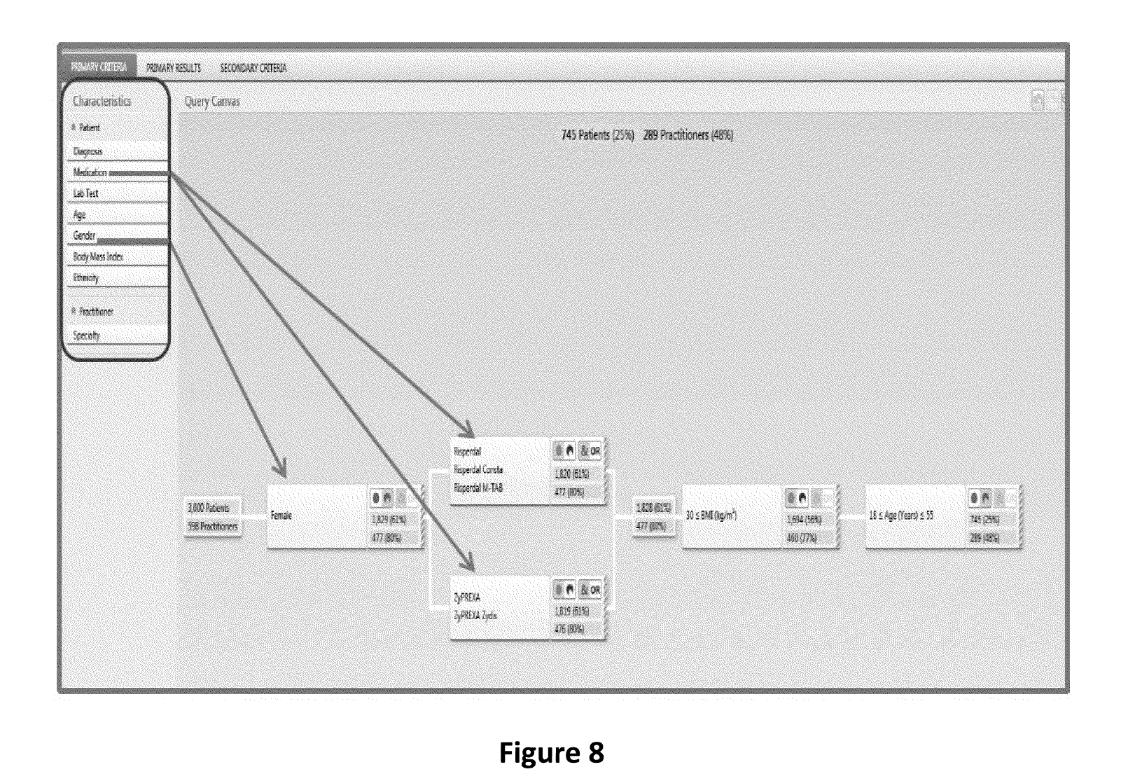

In various aspects, different patient characteristics may be identified or searched. For example, FIG. 6 shows examples of patient characteristics that may be specified or selected, including patient diagnoses, medications, lab tests, age, gender, body mass index, and ethnicity. Still further characteristics may be specified or selected according to various aspects. In the aspect shown in FIG. 6, a user of the computing device 104 may select one or more of the characteristics and may enter data or make selections of values for the selected characteristics, such as ‘male’ or ‘female’ when selecting gender. The selected characteristics may be used to generate one or more queries to be issued to a data store, or may be used to generate a target patient population.

In some aspects, the patient population search criteria may also include provider characteristics. For example, in one aspect, the patient population search criteria may describe characteristics of providers suitable for a clinical trial, such as one or more specialties, a location or region, a clinic size, a university or medical school affiliation, a profit or non-profit status, or other characteristics.

Referring again to FIG. 3, in an aspect, the computing device 104 may also receive provider records 308. As discussed above, provider records may contain records of patients of one or more providers, records of investigators of clinical trials, or specialties of one or more providers. Aspects may employ provider records 308 to identify one or more patients for a target patient population. For example, provider records 308 may include records of one or more patients, which in some cases may be anonymized or de-identified. In some cases, the provider records 308 may or may not include patient records, but may include specialty information for a provider. Such information may be used when selecting a target patient population to select practitioners likely to have patients relevant to the target population. For example, in a clinical trial related to a cardiac treatment, provider records indicating a cardiology specialty, irrespective of any specific patient information, may indicate a source of patients for a clinical trial.

Further, in some aspects, candidate patients may be excluded from a patient population if they are not associated with one or more providers. For example, one or more patients may have characteristics that are compatible with a target patient population, however, due to identification of one or more providers, the patient may be excluded as being unsuitable due to a lack of a relationship with the identified one or more of the identified providers. Such an exclusion may be based on parameters associated with the target patient population. For example, a clinical trial sponsor may require that candidate patients be associated with one or more specified providers, or may require that candidate patients must be associated with a provider or with a particular geographic region. In some aspects, a patient may be excluded based on an association with a provider that has performed poorly in previous clinical trials, or where the patient is the only patient in the population that is associated with the provider.

Referring again to FIG. 6, a user of the computing device 104 may be able to select a practitioner specialty when performing the search. For example, a user may select the Practitioner “Specialty” button and be presented with a list of available specialties for selection, as may be seen in FIG. 7. Such a selection may be used to specify characteristics of provider records to be retrieved from an external data source, such as the provider records data store 112 or the clinical trial records data store 116, or to search provider records that have been received by, or that are stored on, the computing device 104.

Referring again to FIG. 3, in an aspect, the computing device 104 may also receive investigator records 309. Investigator records may contain information related to investigators used during prior clinical trials. According to some aspects, investigator records may include references to records of patients of one or more providers, records of providers, or specialties of one or more investigators or providers. Investigator records may also include information related to a past performance of one or more of the investigators. Aspects may employ investigator records 309 to identify one or more patients for a target patient population. For example, investigator records 308 may include or be associated with records of one or more patients or records of one or more providers. Such records may be anonymized or de-identified in some aspects. Such information may be used when selecting a target patient population to select investigators having links to large numbers of potentially-relevant patients or links to large numbers of potentially-relevant providers. For example, in a clinical trial it may be desirable to identify investigators with significant numbers of patients available to target for recruitment.

In some aspects, the computing device 104 may receive EHRs 306 from one or more external data sources, such as EHR data store 110 or server device 106, or may have one or more EHRs 306 stored within its local data store 212. The computing device 104 may search the EHRs 306 according to the patient population search criteria 302, the provider records 308, or the investigator records 309. For example, the computing device 104 may generate one or more search queries based on the search criteria and issue the search query(ies) to, for example, the EHR data store 110. In some aspects, the computing device 104 may employ information associated with one or more provider records 308 or one or more investigator records 309 to search EHRs. For example, in one aspect, the computing device 304 may generate one or more search queries to search the EHRs based on a provider name, a provider specialty, a provider address, or other information associated with one or more provider records 308 or one or more investigator records 309. As described above, a provider record 308 or an investigator record 309 may or may not include patient information, however, one or more EHRs may include data that indicates one or more providers, such as a cardiologist associated with a patient.

The computing device 104 may employ the patient population search criteria 302 to access and search one or more of the EHRs, the provider records 308, or the investigator records 309. For example, in one aspect, the computing device may generate one or more queries based at least in part on the patient population search criteria 302 to identify one or more EHRs that satisfy the query(ies). Responsive EHRs may include one or more patient records having information associated with one or more characteristics specified in the patient population search criteria 302, such as a gender, age, etc. In another aspect, the computing device 104 may generate one or more queries based at least in part on the patient population search criteria 302 to identify one or more providers that satisfy the query(ies). For example, the query(ies) may be submitted to an external data source, such as the provider records data store 112 or server device 108. In some aspects, one or more provider records may be cross-referenced to identify one or more patients associated with a provider record 308, such as by identifying other patients associated with the cardiologist or the provider. Such information may also be used to search the provider records to identify one or more providers that may have or may be likely to have patients relevant to a desired target patient population for a clinical trial.

In some aspects, search criteria may comprise temporal information regarding one or more patient characteristics. While in some aspects patients with diabetes may be desirable, certain events, and the timing of those events, may be of interest. For example, search criteria may comprise an “index event,” which relates to an event of interest and can establish a temporal marker. In addition, the search criteria may include one or more additional events and one or more time periods.

In one aspect, search criteria comprises an index event of a diabetes diagnosis, a second event of beginning oral antidiabetic treatment, and a time period of zero to three days subsequent to index event. In such a case, the computing device 104 queries the EHRs that reference both the index event and the second event, where the second event occurs within the specified time period of the index event. Thus, the computing device 104 may obtain one or more EHRs associated with patients who were diagnosed with diabetes and began using orally-administered antidiabetic medication within three days of the diagnosis.

In some aspects, more than one additional event may be specified, and time periods may indicate time differences between the index event and one or more of the additional events, or may indicate time periods between one or more of the additional events. For example, search criteria comprises an index event of a diabetes diagnosis, a second event of beginning oral antidiabetic treatment, and a third event of obtaining an insulin pump, and specify time periods of three days and six months. In such a case, the computing device 104 queries the EHRs that reference each of the index event and the additional events, where the second event occurs within the first specified time period from the index event and wherein the third event occurs within the second specified time period from the index event. Thus, the computing device 104 may obtain one or more EHRs associated with patients who were diagnosed with diabetes, began using orally-administered antidiabetic medication within three days of the diagnosis, and obtained an insulin pump within six months of diagnosis.

In some aspects, the computing device 104 may receive a query that specifies how many days, weeks, or years of data must exist in a database for each patient after his/her index date. The device may receive a query of specify types of data a priori that can be collected (e.g., HgA1c at 3, 6, and 9 months post index date; all new instances of a SSRI for 1 year post-index date, etc.).

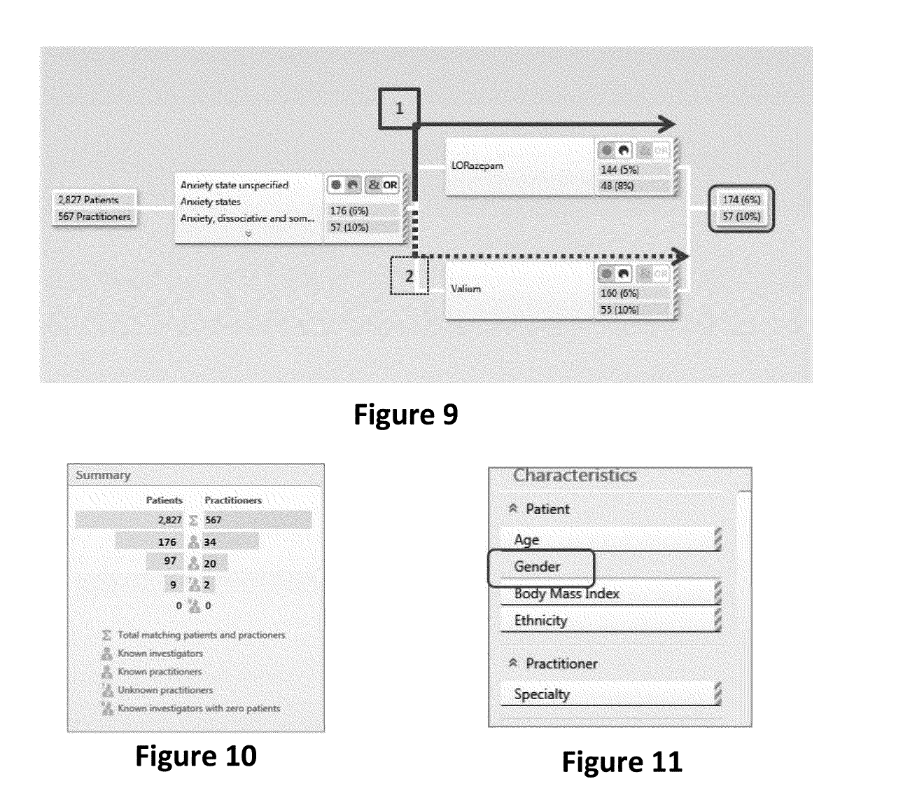

The computing device 304 may then return a resultant patient population 310 based on the patient population search criteria 302, EHRs, the provider records 308, or the investigator records 309, such as the examples shown in FIGS. 9-10. For example a resultant patient population 310 may include one or more patient records from EHRs, the provider records 308, or the investigator records 309 according to the patient population search criteria. In one aspect, the patient population may include one or more anonymized or de-identified patient records.

In some aspects, the resultant patient population 310 may satisfy the patient population search criteria 302 and the data flow of FIG. 3 may conclude. However, in some aspects, the resultant patient population 310 may not satisfy the patient population search criteria, may not include enough patients or a desirable mix of patients, or may otherwise not provide a desirable target patient population. In one aspect, the computing device 104 may determine one or more deviations from a target patient population, and execute one or more methods to refine the patient population or the patient population search criteria 302. For example, a resulting patient population 310 may include patients suitable for a clinical trial according to the patient population search criteria 302, however, the resulting patient population 310 may not match a desirable target patient population, such as because the resulting patient population 310 includes too few patients having a desirable characteristic, or a balance of patients for one or more characteristics may be biased, or too biased, towards one characteristic.

As discussed above, in some cases, it may be desirable to have a 50/50 mix of male and female patients in a target patient population. However, in some aspects, the resulting patient population 310 may have a gender mix of 70/30 of males and females, respectively. Thus, the computing device 104 may refine 312 the patient population search criteria 302 to identify additional female patients suitable for a target patient population.

In one aspect, the computing device 104 can receive additional or secondary search criteria 312 to refine the patient population. In some aspects, the computing device 104 may receive additional or secondary search criteria from an external data source, such as a clinical trial sponsor, or in some aspects, the computing device 104 that is stored locally in the data store 212 or may receive additional or secondary search criteria from user input. In some cases, a resulting patient population 310 may include more patients than needed for a target patient population. For example, while the initial search query may have requested all patients with diabetes being seen by a provider that specializes in endocrinology, the secondary criteria may request that the patient be a certain race and have taken a particular diabetes drug. The computing device 104 may review the patients and providers identified in the results of the initial query, and access the EHR data store 110, the provider records data store 112, or the clinical trial records data store 116 to analyze data or a subset of data linked or indexed with an identified patient and practitioner. This may permit the computing device 104 to refine the patient population. In some aspects, the computing device 104 may request refined patient population search criteria from an external source, such as a clinical trial sponsor, or may obtain refined patient population search criteria from a local data store 212 or from user input.

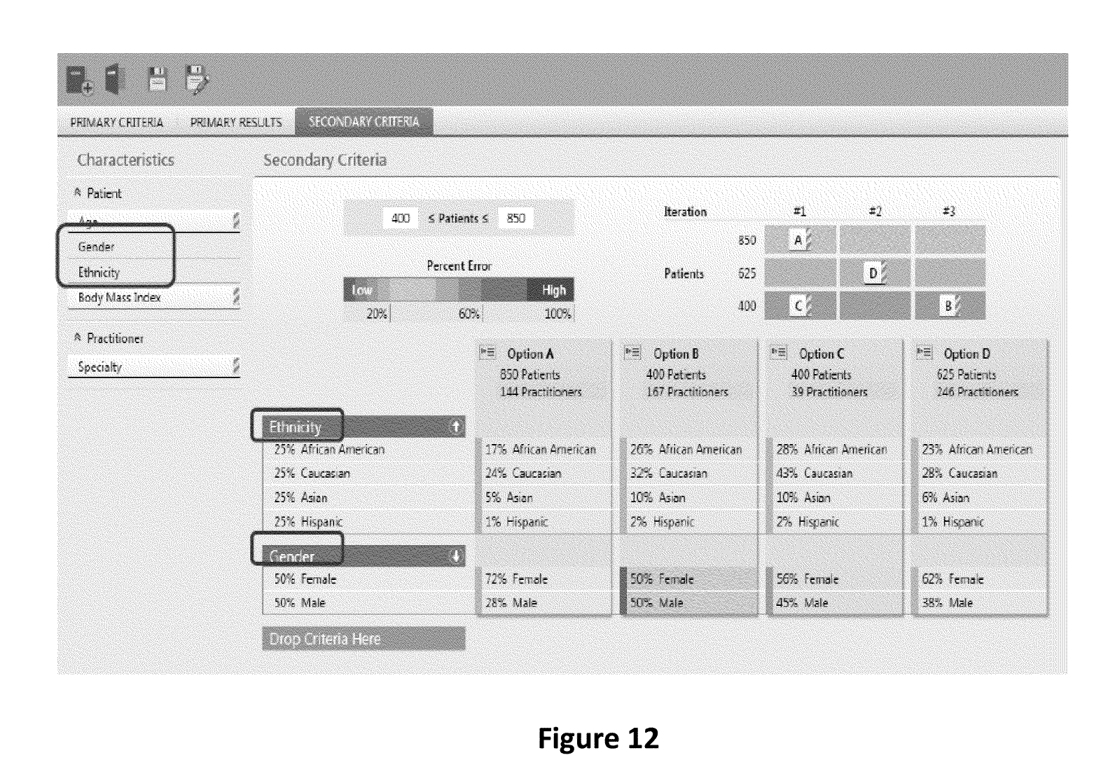

For example, FIG. 11 shows a user interface including selectable patient characteristics in one aspect. The computing device 104 may select one or more patient characteristics that were not included in the initial patient population search criteria 302, or may change values or select additional values for one or more characteristics that were included in the initial patient population search criteria 302. For example, in one aspect, the patient population search criteria specified male and female patients between the ages of 25-34. However, if the resulting patient population 310 had a gender mix of 70/30 of males and females, respectively, the computing device may refine the patient population search criteria to indicate female patients between the ages of 20 and 39, thus potentially resulting in additional suitable female patients. FIG. 12 also depict secondary search criteria 312 that may include patient characteristics, provider characteristics, or additional information desired by a user.

In some aspects, the computing device 104 can use one or more methods when searching and analyzing EHRs and provider records, such as to refine a patient population 314. The computing device 104 can permit one or more methods to be used when conducting a query based on additional or secondary criteria. The secondary criteria method may use an entry in the patient number control and at least one characteristic group for execution. The device may receive a minimum number of patients, a maximum number of patients, or both in the patient number control. In the absence of both a minimum and a maximum, the method may pick target numbers that are 10% and 25% higher/lower than the min/max, respectively. If both min and max are entered, the method may target the min, max, and midpoint.

In certain aspects, there may be at least two different methods that can be used when conducting a query based on additional or secondary criteria. For example, if the primary population contains 500 patients but only 100 patients are needed for the prospective study, secondary criteria can be used to fine-tune the population. Of the 100 patients needed for the study, the device may be requested to have 60% of patients be female and 40% of patients be male. Additionally, the device may be requested to have 80% of patients be age 18-55 and 20% of patients be age 56-65. The gender mix may be a low priority but the age mix may be a high priority. The device may be requested an entry of 95 as the minimum number of patients and 105 as the maximum number of patients.

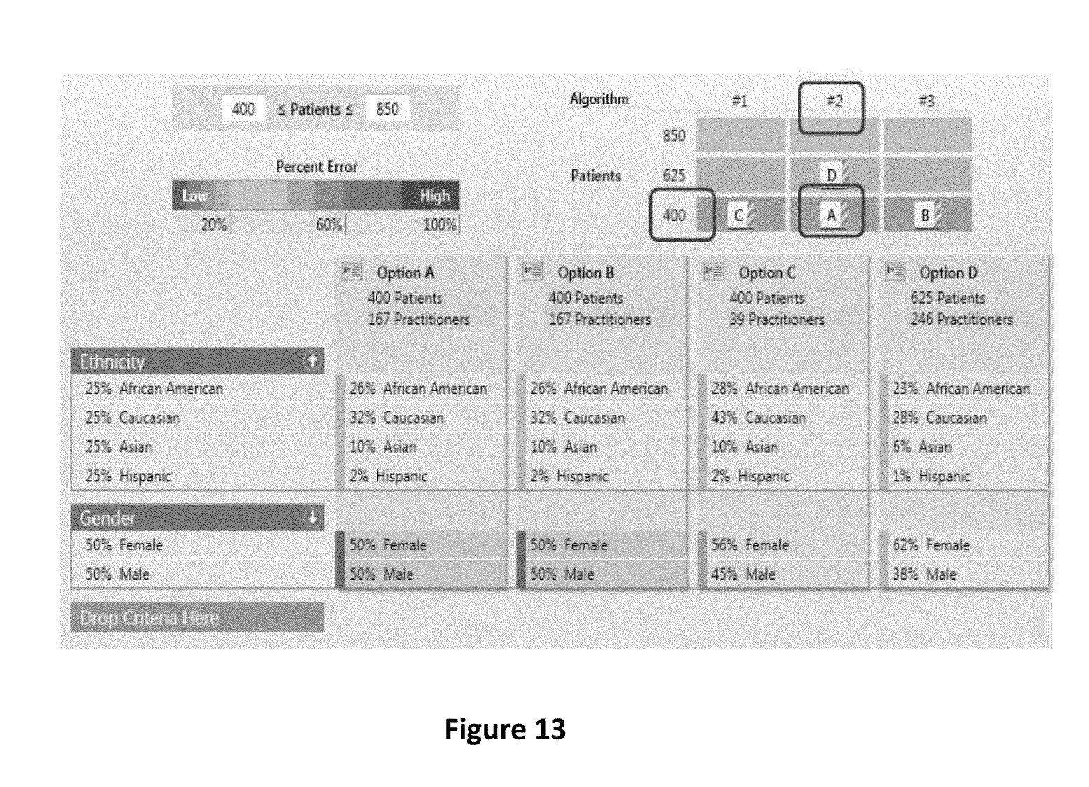

In an example, each of the four methods below may run a total of three times; once each for targets of 95, 100, and 105 patients. This may be used to achieve nine possible results, which may be provided or displayed in a results grid. For example, FIGS. 12 and 13 illustrate example results grids based on multiple executions of one or more methods for generating an electronic representation of the secondary patient population from the primary patient population. The following methods are discussed with respect to the computing device 104 of FIGS. 1 and 2; however, any suitable system may be used to perform one or more of the following methods.

### Method #1

The computing device 104 may begin the method. The computing device 104 may sort patients by gender and age and finds out how many patients fit into the four “cells” calculated in Table 1.

TABLE 1

| | Patient | | Target Number |
|---|---|---|---|
| Cell # | Characteristics | Calculation | of Patients |
| 1 | Female age 18-55 | 0.6 * 0.8 * 100 | 48 |
| 2 | Male age 18-55 | 0.4 * 0.8 * 100 | 32 |
| 3 | Female age 56-65 | 0.6 * 0.2 * 100 | 12 |
| 4 | Male age 56-65 | 0.4 * 0.2 * 100 | 8 |

The components of the calculation in Table 1 are:
Desired gender percentage×desired age percentage×target number of patients=desired number of patients in each cell.
If there are 48 or fewer females age 18-55 in the primary population, all of them can be selected for the secondary population in cell #1.
If there are 49 or more females age 18-55 in the primary population, they are prioritized based on their practitioner (giving first preference to practitioners that already have the most patients in the secondary population and then considering which practitioners have the most total patients in the primary population in the event of a tie); the 48 “best” patients can be selected for the secondary population in cell #1.

The process outlined above can be repeated for each cell. For the purposes of this example, if the primary population includes 40 patients for cell #1 (females age 18-55) but sufficient patients remain to satisfy the remaining three cells (e.g. the primary population contained at least 32 males age 18-55 to fill cell #2).

At this point, the computing device 104 completes execution of the method. In some aspects, the computing device 104 executes one or more of the following methods in addition to method 1.

### Method #2

To make up for the shortage of female patients age 18-55 in cell #1 in this example, this method attempts to select more females age 56-65 (to make up for the shortage of females in cell #1) and more males age 18-55 (to make up for the shortage of patients age 18-55 in cell #1). The addition of each new patient to the secondary population can trigger a new deviation calculation. The method can then analyze the deviations in the age and gender categories and select an additional patient responsive to one or more of the deviations.

In some cases, one or more deviations may indicate to add a female patient regardless of age, but in other cases one or more deviations may indicate to add a patient age 18-55 regardless of gender. The computing device 104 executing Method #2 analyzes one or more of the deviations and selects an additional patient responsive to the one or more deviations. In the event of a tie between multiple available patients (e.g. if the method calculates that selecting a male age 18-55 is the best choice and four males age 18-55 remain in the primary population), those patients are treated equally and, in one aspect, broken patient is selected based on a practitioner, as explained in Method #1. In some aspects, a patient may be selected based on geographic proximity to a clinical trial site, based on a random selection, or other criteria.

Within the secondary population, a device can receive a target patient population that indicates that 60% of patients be female and 40% of patients be male. In addition, the device can receive a request that 80% of patients be age 18-55 and 20% of patients be age 56-65. Continuing with the current example (target secondary population of 100 patients), the computing device 104 receives a target patient population specifying 60 females, 40 males, 80 patients age 18-55, and 20 patients age 56-65. A deviation is calculated based on the difference between the target and actual number of patients in the selected patient population with a given characteristic.

After completing the steps in Method #1 described above, the selected patient population includes 52 females (40 patients from cell #1+12 patients from cell #3) and 40 males (32 patients from cell #2+8 patients from cell #4). The gender deviation is calculated as follows:

General format: |Desired−Actual|/Desired*100=Percent Error; where ‘| |’ indicates an absolute value

Female error: |60−52|/60*100=13%

Male error: |40−40|/40*100=0%

Based on the deviation of 13%, the computing device 104 adjusts a weight parameter to be used to select an additional patient for the patient population based on a female gender.

The same calculation is performed for age. The selected patient population includes 72 patients age 18-55 and 20 patients age 56-65.

Age 18-55 error: |80−72|/80*100=10%

Age 56-65 error: |20−20|/20*100=0%

Based on the deviation of 10%, the computing device 104 adjust a weight parameter to be used to select an additional patient for the patient population based on age between 18-55

In this example, the gender deviation (13%) is greater than the age deviation (10%), so the computing device 104 selects a value for a weight parameter associated with gender that is greater than a value for a weight parameter associated with age. Based on the deviations or the weights, the computing device 104 modifies its search to females in the primary population. The computing device 104 filters the list of females by age and selects a patient that is 18-55 years old. However, method 1 indicated that there were not sufficient female patients between the ages of 18-55 (cell #1 in Method #1 had a shortage), so the computing device 104 must select a female that is not between the ages of 18 and 55. In this example, there are sufficient females outside of this age range (there are over 400 patients remaining in the primary population), so it is likely that many female patients that are equally desirable based on patient characteristics alone. Therefore, the device can prioritize the selection based on practitioner links as described earlier in Method #1.

For this example, assume that the device selected a female that is 62 years old. The deviations are recalculated before the next selection. The population at this time includes 53 females age 18-55. The gender deviation is calculated as follows:

Female error: |60−53|/60*100=12%

Male error: |40−40|/40*100=0%

The population at this time includes 72 patients age 18-55 and 21 patients age 56-65. The age deviation is calculated as follows:

Age 18-55 error: |80−72|/80*100=10%

Age 56-65 error: |20−21|/20*100=5%

Based on the gender deviation, the total gender deviation is 12%+0%=12% and the computing device 104 sets a weight parameter to indicate that a female patient would be preferable to a male patient (there are not enough females whereas there are already enough males). Based on the age deviation, the total age error would be 15% and the computing device 104 sets a weight parameter to indicate that selecting a patient age 18-55 would be preferable to selecting a patient age 56-65 (there are not enough patients age 18-55 whereas there are already enough patients age 56-65). In this case, note that too many patients with a certain characteristic (e.g. patients age 56-65) can add to the overall deviation but it does not mean that a patient with that characteristic should be chosen.

In this example, the age deviation (15%) is greater than the gender deviation (12%), so the computing device 104 selects a value for a weight parameter associated with age that is greater than a value for a weight parameter associated with gender. Based on the deviations or the weights, the computing device 104 modifies its search to identify patients that are 18-55 years old in the primary population. The computing device 104 filters the primary population by gender. Again, in this example, the gender deviation indicates that female patients are needed, and further that the primary population does not include sufficient female patients between ages 18-55, so the computing device 104 selects a male between the ages of 18 and 55. In this example, there are sufficient males in this age range (there are over 400 patients remaining in the primary population), so it is likely that many male patients that are equally desirable based on patient characteristics alone. Therefore, the device can prioritize the selection based on practitioner links as described earlier in Method #1.

For the example, the computing device selects a male that is 50 years old. The deviations are recalculated and this process continues until 100 patients have been chosen for the secondary population.

### Method #3

Continuing with the current example (target secondary population of 100 patients), the computing device 104 receives a target patient population of 60 females, 40 males, 80 patients age 18-55, and 20 patients age 56-65. The deviations are based on the difference between the target and actual number of patients with a given characteristic.

For this example, assume that Method #3 has already chosen 50 patients with 30 females and 20 males in the secondary population and there are 29 patients age 18-55 and 21 patients age 56-65 in the secondary population. A difference between Method #3 and Method #2 described above is that in some aspects method 3 uses an deviation multiplier. When the computing device 104 initiates execution of method 3, it receives a target patient population that includes parameters indicating that a gender mix is a low priority but an age mix is a high priority. In this example, high, medium, and low priority characteristics have deviation multipliers of 3, 2, and 1, respectively.

However, in other aspects, different multipliers, or weights, may be assigned, or different numbers of multipliers or weights may be used. The computing device 104 computes a deviation according to the following:

General format: |Desired−Actual|/Desired*100*Error Multiplier=Percent Error

Female error: |60−30|/60*100*1=50%

Male error: |40−20|/40*100*1=50%

The age deviation calculation is shown below:

Age 18-55 error: |80−29|/80*100*3=191%

Age 56-65 error: |20−21|/20*100*3=15%

Based on these calculations, the total gender deviation is 50%+50%=100% and selecting a female or male, indicating that no bias in selecting a patient is needed based on gender. Further, based on these calculations, the total age deviation is 206% and the deviations indicate that the computing device 104 should set a weight parameter to indicate that selecting a patient age 18-55 would be preferable to selecting a patient age 56-65, because in this example there are not enough patients age 18-55 whereas there are already enough patients age 56-65. In this case, note that too many patients with a certain characteristic can add to the overall error but it does not require that a patient with that characteristic must be selected.

The age deviation (206%) is greater than the gender deviation (100%), so the computing device 104 selects weight parameters to indicate that a patient age 18-55 is desirable. The computing device 104 modifies its search to identify candidate patients that are 18-55 years old in the primary population. The computing device 104 filters primary population by gender and identifies patients between 18-55 years old. In this example, it is likely that there are many patients in this age range (there are over 400 patients remaining in the primary population), so the computing device 104 can prioritize the selection based on practitioner links as described earlier in Methods #1 and #2.

After a patient is selected, the deviations can be recalculated before the next selection, and this process can continue until 100 patients have been chosen for the secondary population.

### Method #4

Method #4 is identical to Method #3 but uses different deviation multipliers. Method #4 uses multipliers of 6, 3, and 1 for high, medium, and low priority characteristics, respectively. As a result, Method #4 can give strong preference to minimizing deviations in high priority categories, possibly at the expense of introducing greater deviations in low or medium priority categories.

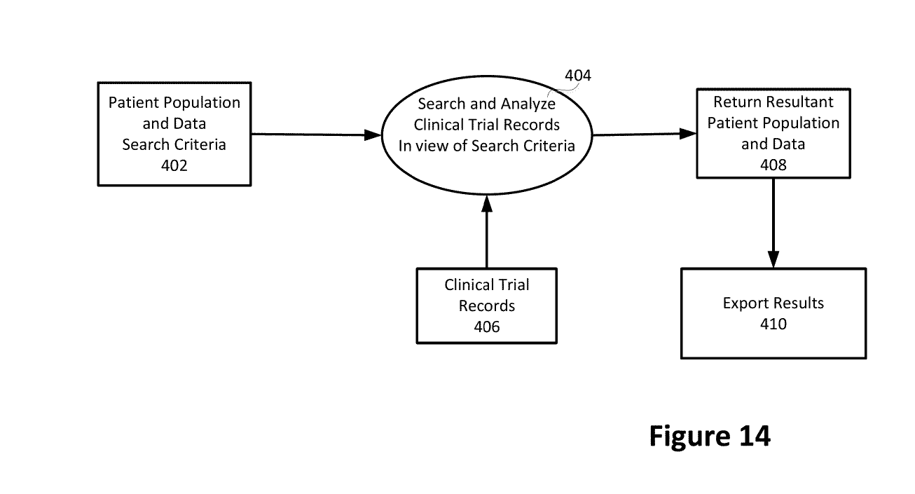

In certain aspects, if the computing device 104 receives a target population that indicates more patients than there are patients available in the primary population, each patient from the primary population can be added to the secondary results list. FIG. 14 is a data flow diagram that depicts an example of obtaining data associated with a primary or secondary patient populations. FIG. 14 includes an example of certain processes that can be performed by the computing device 104 of FIGS. 1-2.

In some aspects, after determining the refined resultant patient population according to one or more of methods 1-4, the computing device 104 may further iteratively refine the patient population search criteria 312 and perform additional queries and analysis 314, such as by employing repeated executions of one or more of methods 1-4. Or in some aspects discussed below, refined patient search criteria may be modified based on feedback, such as refined resultant patient populations deviating from a desired result as described above. Thus, a user may, in real-time adjust secondary or refined patient search criteria and review the refined resultant patient populations, such as the example shown in FIG. 13, to better tailor the target patient population.

After obtaining the resulting patient population, the computing device 104 may output the resulting patient population 316, such as by generating one or more data files or generating a textual report. For example, in one aspect, the computing device 104 may output information relating to one or more patients in the resulting patient population 316. In some aspects, such as in cases when the patient EHRs are de-identified, the computing device 104 may output a list of providers associated with patients in the resulting patient population. In some aspects, the list of providers may also include information associated with patients in the resulting population that are associated with the providers, such as demographics or specific information from the patients' EHR (e.g. lab values, medications, etc.). When patient records are de-identified, it may be possible to contact a provider who has been shown to have patients in the patient population and ascertain whether he or she may be interested in participating in a particular clinical trial. In some aspects, the provider might also be requested to provide additional information regarding a particular patient in a de-identified manner, or information obtained when placing patients in the patient population may help a practitioner to further treat a specific patient or type of patients.

In some aspects, a provider may employ such results in planning treatment or determining potential treatment efficacy for a specific patient. For example, a provider may employ such results to determine a course of treatment for a particular patient based on data regarding treatment of patients in the resulting patient population, or to provide more general guidance regarding treatment of future patients.

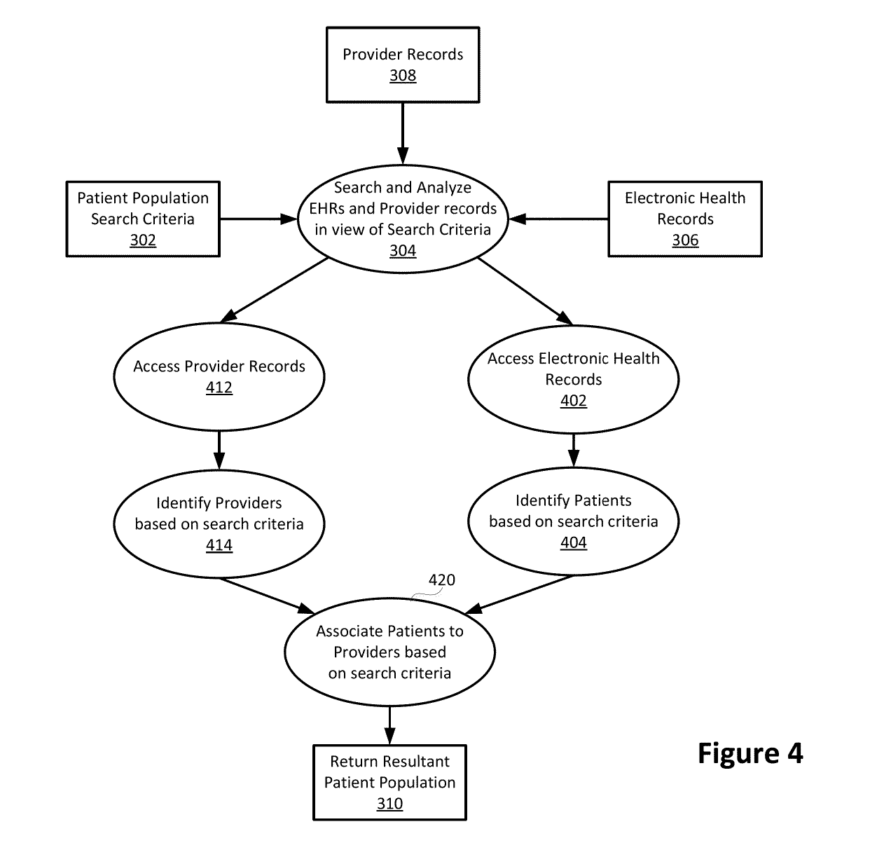

Referring now to FIG. 4, FIG. 4 shows a flow chart that depicts an example of certain processes that can be performed by various systems according to this disclosure. In this example, the flow chart is discussed with respect to the computing device 104 of FIGS. 1-2. As discussed above with respect to FIG. 3, the computing device 104 may receive patient population search criteria 302 and EHRs 306 or provider records 308, and generate one or more queries to generate a resultant patient population 310. In the aspect shown in FIG. 4, the computing device 104 receives both provider records 308 and EHRs 306, accesses the provider records 412 and accesses the EHRs 402 and identifies providers 414 and patients 404 based on the results of the one or more queries. In addition to generating a resultant patient population 310, the computing device 104 in this aspect is also configured to associate patients to providers 420.

For example, the computing device 104 can associate a current or former patient of a provider with that particular provider. This permits a connection between a patients and providers that meet the search criteria to be identified. As discussed above, EHRs may indicate that a patient sees or has seen a particular provider, such as an endocrinologist, that has a corresponding provider record 308. However, neither the EHR(s) nor the provider record(s) may include an explicit association to the other record(s). Thus, according to the example shown in FIG. 4, the computing device 104 may create an explicit association between the EHR(s) and the provider record(s). In the example shown in FIG. 4, the computing device 104 may store an explicit association to the corresponding provider record(s) in the EHR(s) or it may store an explicit association to the corresponding EHR(s) in the provider record(s).

In some examples, the computing device 104 may generate a separate record to store an explicit association between one or more EHRs and one or more provider records. In one example, the associations are stored in one of the external data stores 110, 112, 116 as new records. In one example, the associations are stored in the local data store 212. Further, such associations may be explicitly linked with one or more EHRs or one or more provider records, such as by one or more foreign keys. In some example, however, the associations are not explicitly linked. Thus, the computing device 104 may generation one or more associations between EHRs and provider records. Such associations may then be employed in subsequent searches and analyses of potential patients and providers for target patient populations, including as a part of refining resulting patient populations as described with respect to FIG. 3.

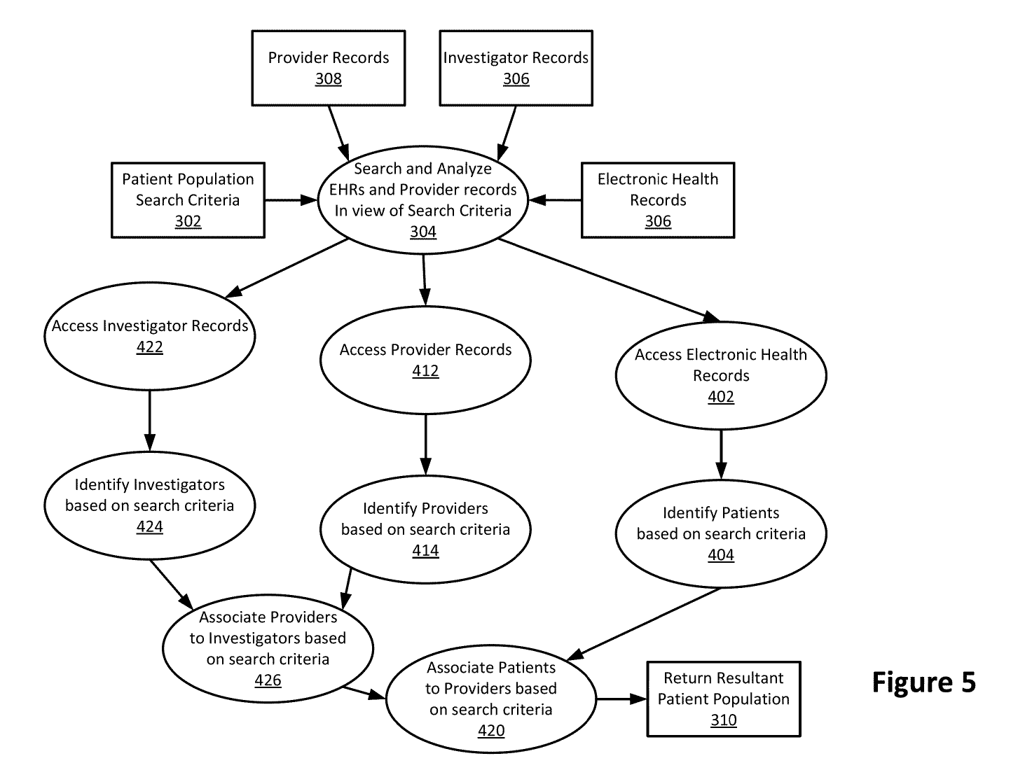

Referring now to FIG. 5, FIG. 5 shows a flow chart that depicts an example of certain processes that can be performed by various systems according to this disclosure. In this example, the flow chart is discussed with respect to the computing device 104 of FIGS. 1-2. As discussed above with respect to FIG. 3, the computing device 104 may receive patient population search criteria 302 and EHRs 306 or provider records 308, and generate one or more queries to generate a resultant patient population 310. In the aspect shown in FIG. 5, the computing device 104 receives provider records 308, EHRs 306, and investigator records 309, accesses the provider records 412 and accesses the EHRs 402 and identifies providers 414 and patients 404 based on the results of the one or more queries. In addition to generating a resultant patient population 310, the computing device 104 in this aspect is also configured to associate patients to providers 420 and to associate providers and investigators 426.

For example, one or more providers may have a significant number of patents that may be recruited for a clinical trial, and the provider may have previously functioned as an investigator during clinical trials. However, neither the provider record(s) nor the investigator record(s) may include an explicit association to the other record(s). Thus, according to the example shown in FIG. 5, the computing device 104 may create an explicit association between the provider record(s) and the investigator record(s). In the example shown in FIG. 5, the computing device 104 may store an explicit association to the corresponding investigator record(s) in the provider record(s) or it may store an explicit association to the corresponding provider(s) in the investigator record(s).

In some examples, the computing device 104 may generate a separate record to store an explicit association between one or more investigator records and one or more provider records. In one example, the associations are stored in one of the external data stores 110, 112, 116 as new records. In one example, the associations are stored in the local data store 212. Further, such associations may be explicitly linked with one or more investigator records or one or more provider records, such as by one or more foreign keys. In some example, however, the associations are not explicitly linked. Thus, the computing device 104 may generation one or more associations between investigator records and provider records. Such associations may then be employed in subsequent searches and analyses of potential patients, providers, or investigators for target patient populations, including as a part of refining resulting patient populations as described with respect to FIG. 3.

Referring now to FIG. 14, FIG. 14 shows a flow chart that depicts an example of obtaining data associated with primary or secondary patient populations. In certain aspects, if the computing device 104 receives a request for more patients for the secondary population than there are patients available in the primary population, each patient from the primary population can be added to the secondary results list. FIG. 14 includes an example of certain processes that can be performed by the computing device 104 of FIGS. 1-2.

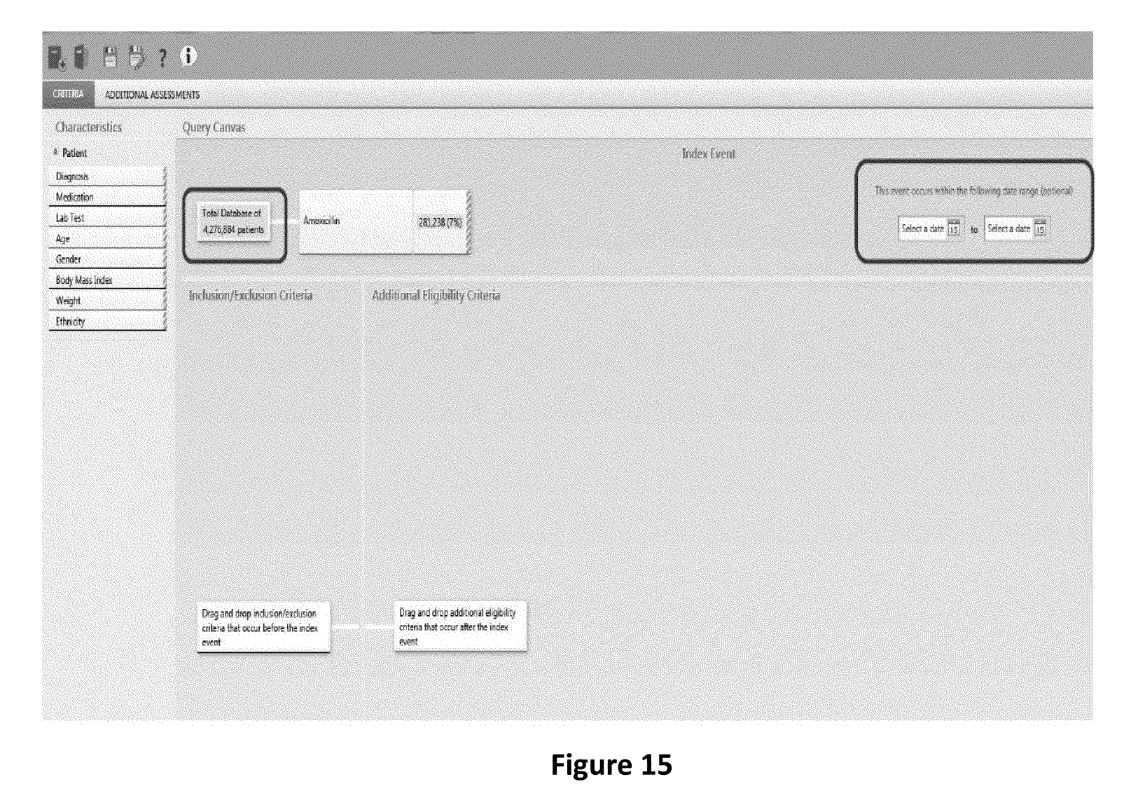

The computing device 104 can receive patient criteria that may include past information about a patient, a time frame in which to locate patients that meet certain patient criteria, and data elements of interest related to patient criteria 302, such as may be seen in FIG. 15. The computing device 104 may search and analyze 404 clinical trial investigator records 406 in view of the search criteria to determine patients that meet the patient criteria and provide data elements of interest for the patients that were identified 404. For example, the computing device may user may provide a query that request a list of patients have taken a certain drug from 2000 and 2010 or data for the patients reaction to that drug. The results of the patient population and data regarding that patient population may be returned to a user 408. A data set may be generated and the user may view or export the data set to a device, such as Excel or SAS 410.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation. Further the use of the term “based on” is intended to mean “based at least in part on,” depending on the context.

That which is claimed is:

1. A method comprising:
obtaining an electronic representation of a primary patient population within a first data store, the primary patient population comprising a plurality of electronic health records (EHRs);
receiving an electronic representation of a target secondary patient population, the target secondary patient population comprising a target number of patients and at least one characteristic; and
generating an electronic representation of the secondary patient population from the primary patient population based on the target number of patients and the at least one characteristic.

2. The method of claim 1, wherein generating the electronic representation of the secondary patient population from the primary patient population comprises using a means for generating the electronic representation of the secondary patient population.

3. The method of claim 1, wherein generating the electronic representation of the secondary patient population comprises iteratively generating an electronic representation of the secondary patient population from the primary patient population based on the target number of patients and the at least one characteristic, comprising:
determining a deviation of the secondary patient population from the target secondary patient population based on the target number of patients and the characteristic; and
obtaining an electronic representation of at least one additional patient for the secondary patient population from the primary patient population or the first data store based on the deviation.

4. The method of claim 1, further comprising:
receiving a provider characteristic;
accessing a second data store to obtain data records corresponding to one or more providers based on the provider characteristic; and
selecting at least one provider based on the data records.

5. The method of claim 4, further comprising:
accessing a third data store to obtain data records associated with one or more investigators;
determining an association between the selected provider and at least one of the one or more investigators; and
selecting at least one investigator based on the association.

6. The method of claim 4, further comprising determining an association between one or more patients and the at least one provider.

7. The method of claim 1, further comprising:
receiving an index event and a second event associated with the index event;
receiving a time period, the time period associated with a difference in time between the index event and the second event;
and wherein obtaining an electronic representation of a primary patient population comprises obtaining EHRs associated with patients, the EHRs indicating occurrence of the index event and the second event, the second event occurring within the time period based on the index event.

8. A system comprising:
a computer-readable medium; and
an electronic processor in communication with the computer-readable medium, the electronic processor configured to:
obtain an electronic representation of a primary patient population within a first data store, the primary patient population comprising a plurality of EHRs;
receive an electronic representation of a target secondary patient population, the target secondary patient population comprising a target number of patients and at least one characteristic; and
generate an electronic representation of the secondary patient population from the primary patient population based on the target number of patients and the at least one characteristic.

9. The system of claim 8, further comprising means for generating the electronic representation of the secondary patient population.

10. The system of claim 8, wherein the processor is further configured to:
iteratively generate the electronic representation of the secondary patient population from the primary patient population based on:
the target number of patients and the at least one characteristic,
a determination of a deviation of the secondary patient population from the target secondary patient population based on the target number of patients and the characteristic, and
an electronic representation of at least one additional patient from the primary patient population or the first data store based on the deviation.

11. The system of claim 8, wherein the processor is further configured to:
receive a provider characteristic;
access a second data store to obtain data records corresponding to one or more providers based on the provider characteristic; and
select at least one provider based on the data records.

12. The system of claim 11, wherein the processor is further configured to:
access a third data store to obtain data records associated with one or more investigators;
determine an association between the selected provider and at least one of the one or more investigators; and
select at least one investigator based on the association.

13. The system of claim 11, wherein the processor is further configured to determine an association between one or more patients and the at least one selected provider.

14. The system of claim 8, wherein the processor is further configured to:
receive an index event and a second event associated with the index event;
receive a time period, the time period associated with a difference in time between the index event and the second event;
and wherein the processor is further configured to obtain the electronic representation of the primary patient population based on EHRs associated with patients, the EHRs indicating occurrence of the index event and the second event, the second event occurring within the time period based on the index event.

15. A computer-readable medium comprising program code for causing an electronic processor to execute a method, the program code comprising:
program code for obtaining an electronic representation of a primary patient population within a first data store, the primary patient population comprising a plurality of EHRs;
program code for receiving an electronic representation of a target secondary patient population, the target secondary patient population comprising a target number of patients and at least one characteristic; and
program code for generating an electronic representation of the secondary patient population from the primary patient population based on the target number of patients and the at least one characteristic.

16. The computer-readable medium of claim 15, wherein the program code for generating the electronic representation of the secondary patient population from the primary patient population comprises program code for using a means for generating the electronic representation of the secondary patient population.

17. The computer-readable medium of claim 15, wherein program code for generating the electronic representation of the secondary patient population comprises program code for iteratively generating an electronic representation of the secondary patient population from the primary patient population based on the target number of patients and the at least one characteristic, comprising:
program code for determining a deviation of the secondary patient population from the target secondary patient population based on the target number of patients and the characteristic; and
program code for obtaining an electronic representation of at least one additional patient for the secondary patient population from the primary patient population or the first data store based on the deviation.

18. The computer-readable medium of claim 15, further comprising:
program code for receiving a provider characteristic;
program code for accessing a second data store to obtain data records corresponding to one or more providers based on the provider characteristic; and
program code for selecting at least one provider based on the data records.

19. The computer-readable medium of claim 18, further comprising:
program code for accessing a third data store to obtain data records associated with one or more investigators;
program code for determining an association between the selected provider and at least one of the one or more investigators; and
program code for selecting at least one investigator based on the association.

20. The computer-readable medium of claim 18, further comprising program code for determining an association between one or more patients and the at least one provider.

21. The computer-readable medium of claim 15, further comprising:
program code for receiving an index event and a second event associated with the index event;
program code for receiving a time period, the time period associated with a difference in time between the index event and the second event;
and wherein the program code for obtaining an electronic representation of a primary patient population comprises program code for obtaining EHRs associated with patients, the EHRs indicating occurrence of the index event and the second event, the second event occurring within the time period based on the index event.
